(19) United States
(12) Patent Application Publication
(10) Pub. No.: US 2004/0118671 A1
(43) Pub. Date: Jun. 24, 2004

(54) Method and apparatus for the thermo-solar distillation and transportation of water from a water table

(76) Inventor: Victor Miguel Hernandez Burgos, Torren (MX)

Correspondence Address: BACHMAN & LAPOINTE, P.C., 900 CHAPEL STREET, SUITE 1201, NEW HAVEN, CT, 06510, US

(21) Appl. No.: 10/621,225

(22) Filed: Jul. 15, 2003

Related U.S. Application Data
(63) Continuation-in-part of application No. 09/923,226, filed on Aug. 6, 2001, now Pat. No. 6,673,213.

(51) Int. Cl. B01D 3/00; B01D 3/10

(52) U.S. Cl. 203/10; 203/100; 203/DIG. 1; 202/234; 202/185.5; 202/185.6; 159/903

(57) ABSTRACT

A simultaneous system for the distillation and elevation of water on top of the water table itself, which drastically reduces the effects of scaling and corrosion, which, driven by thermo solar energy in an autonomous operation allows for the transportation and generation of electrical power.

The present invention refers to a novel method designed to obtain water by means of thermo-solar evaporation, and condensing and transporting this water to a place distant, be it for the use of the water itself or for the generation of electric power.

The problem of furnishing water for domestic as well as for industrial use is widely known; the shortage of water for land and cattle farming purposes is also critical.

Due to this systems have been developed in order to transport water to the sites where it is needed, or recourse to the perforation of wells is taken in order to extract water from the subsoil. Known water transportation systems are highly expensive and in most cases prohibitive for the above purposes; on the other hand, extraction of water from the subsoil is not always successful, this without considering the cost of the necessary energy and the fact that the tables are being depleted.

Another alternative to date has been the distillation of salt water from the oceans, which is the most abundant source of our planet, although this has proven not to be very practical and convenient in view of the problems which arise due to corrosion and salt scaling, feasibility being achieved at very high cost by overcoming these problems with the aid of chemical inhibitors and pretreatments, thus rendering this alternative uneconomical.

In the light of this it is highly desirable to find an effective and economical way of obtaining water, and also transporting it at reasonable prices.

An object of the present invention is to furnish a method which allows the evaporation of water from a water table, be it fresh water or salt water, by using solar energy.

A further object of the invention is to furnish an apparatus for the transportation of the once condensed water obtained by the above method, if necessary over considerable distances which may include rough terrain. The invention also covers the possibility of generating electricity by means of free falling water.

Other uses, objects and advantages of this invention will be self-evident or will be specified in the following detailed description of the invention.

Basically the invention comprises the concentration of solar rays by way of any kind of solar thermal energy collectors, of any type which may be of the parabolic channel type (eventually elliptical or circular) which, upon receipt of the sun rays concentrate them at the focal point producing high temperatures; at the focal point there is located a tube through which circulating oil continues to flow through a coil which is submerged under a thin water layer of a table; as a result of the high temperature achieved in the coil the water boils and evaporates.

In the coil a constant temperature is maintained by forcing the circulation of oil through the coil by means of an electric pump. This electric pump runs on electric power produced by photovoltaic cells; the necessary connections are furnished in order for the hot oil to reach the coil and apply on the water the maximum temperature concentrated by means of the sun ray collector, thus producing the evaporation of the water at the pressure required for it to rise to a preset height in a rising tower.

The coil is located inside a vat which has a funnel like bottom and maintains a high temperature isolated from the rest of the table, and which, when evaporation takes place leaving a higher concentration of salt in the water because of the higher density due to its funnel like bottom brings about the dislodgement of the salts and also the entrance of new water to be desalted through the holes which to that effect are available in the upper part.

A continuous rising capacity of the water steam is achieved if the temperature in the rising tower is maintained as well as by constantly increasing the flow area, which relieves the steam flow by reducing frictional losses.

Condensation of the water steam is achieved by shock and refrigeration of the water steam as it hits a cover or ceiling wherein are furnished cooling fins or any other heat dissipating means, and canals where the steam condenses and can be collected. The canals are designed (in which way) so as to allow for easy formation and runoff of droplets. The cover or ceiling is manufactured of a material having good thermal conductive properties which allows for a more rapid dissipation of heat and can be manufactured, e.g., of aluminum.

The water in the top part of the tower is caused to descend through a pipeline of proper dimensions as regards the steam volume being fed; the pipeline will be laid so that it forms a descending slope which allows a water flow to build up by gravity, producing a vacuum which enhances circulation and further suction of steam. There also will be siphons installed along the pipeline, which in spite of topographic conditions allow the water to flow even over small elevations or mounds due to the effect of the law governing the continuity of matter (rising of water in canals). From the above readings it will become evident to a person of skill in the art that it is possible to generate electric power taking advantage of the water falls in order to drive hydraulic turbines as many times as the topography will allow for it, or even better, to drive water directly up in order to have it fall for the use in the generation of electrical power, that is to say, to directly feed power generating plants, furnishing afterwards the water for whatever other use(s) it may be needed.

The procedure of evaporation, elevation and transportation of the water may be repeated as many times as it is deemed necessary in order to transport water through valleys and mountains.

Following the invention will be illustrated by way of a preferred embodiment of same which only is to be considered as a non limiting example, since several variations and embodiments may be thought of without departing from the spirit and coverage of the invention, which shall be considered in its more ample, in no way limiting sense.

In the accompanying drawing:

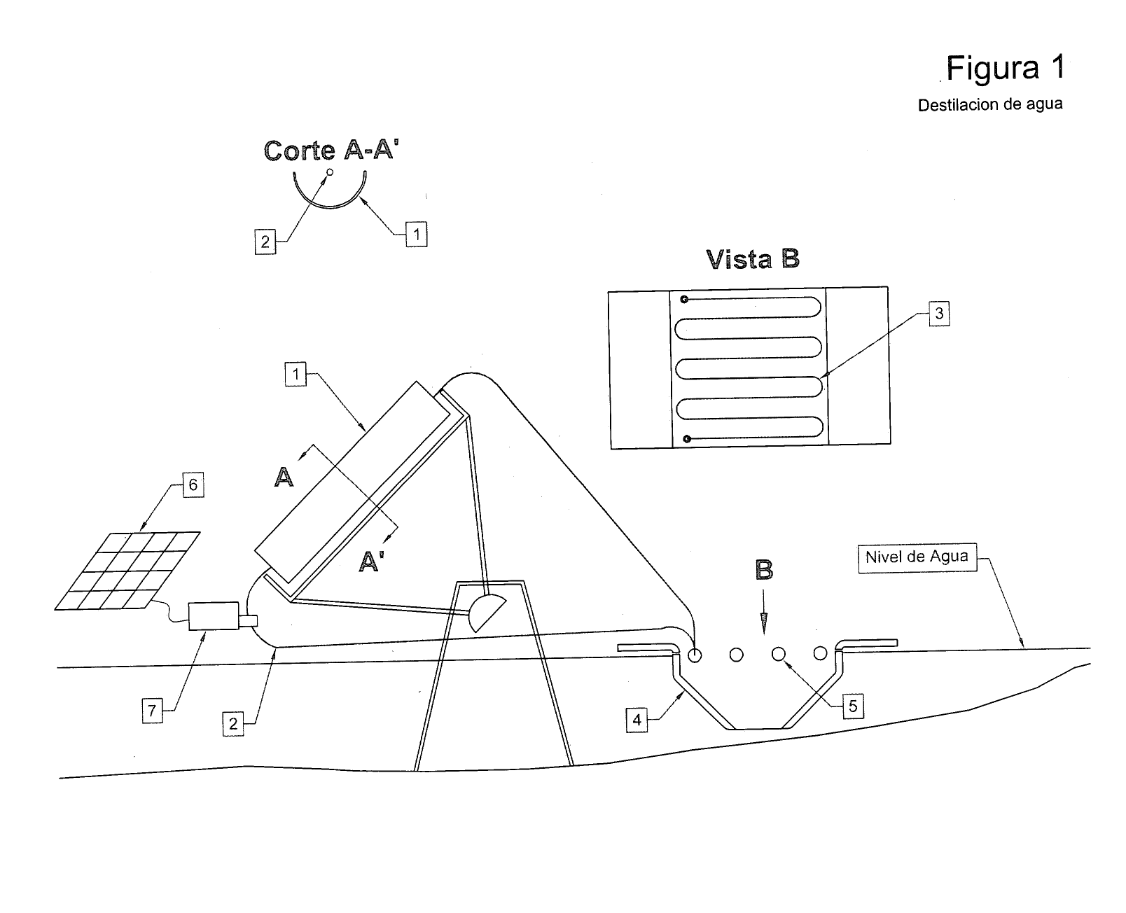

FIG. 1 shows a sectional side view of a water distilling plant built according to the present invention,

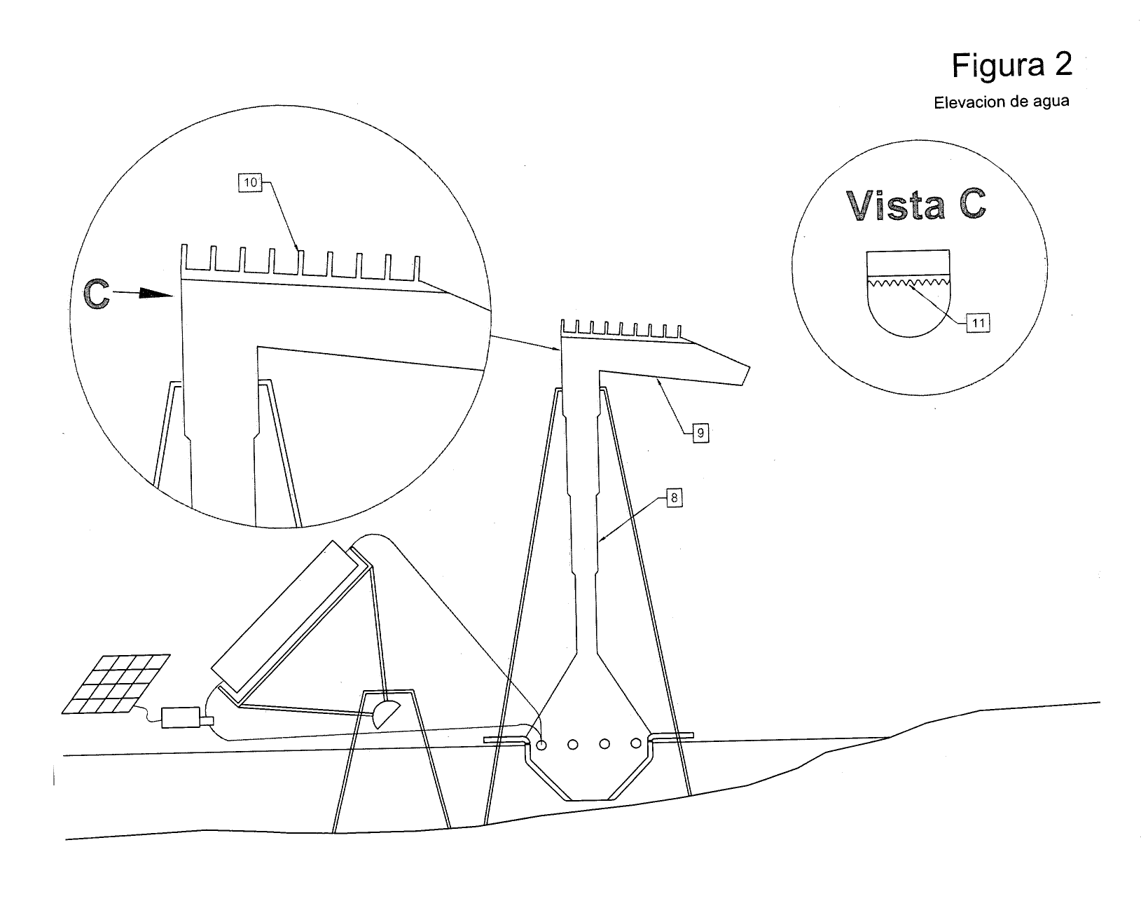

FIG. 2 shows the plant of FIG. 1 in which the steam rising tower has been included, and

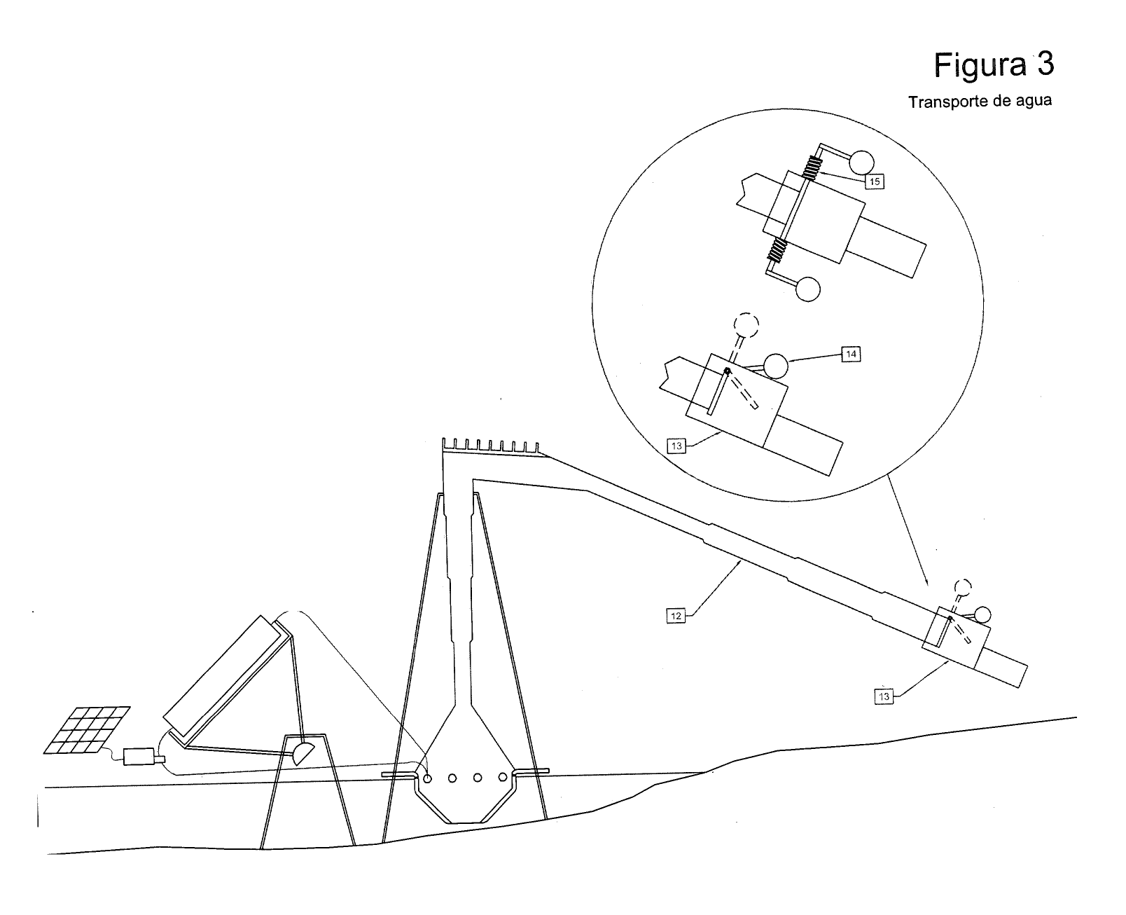

FIG. 3 shows in particular a trap which allows for the selective opening of a cover.

In FIGS. 1 through 3 same reference numbers are used for equal or corresponding parts, for a better understanding of the present invention.

With reference to the figures and in particular to FIG. 1, there is shown a solar thermal energy collector (1) which concentrates the solar energy harnessed in the focal point consisting of a pipe (2) through which flows the hot fluid (oil), which

pipe (2) is connected to a coil (3) located inside a funnel (4) submerged in a water table; in the funnel (4) there are furnished holes (5) at a height preset to maintain in the inside a water level sufficient to replenish the water which boils and evaporates, while also water with a higher salt density is dislodged by gravity through the underside outlet of the funnel because of this higher density. There is also included a photovoltaic cell panel (6) which furnishes the electrical power to drive the pump (7) which keeps the fluid flowing from the collector to the coil and back again to the collector in order to be reheated.

FIG. 2 shows the steam rising tower (8) in which there are furnished enlargements distributed to expand and relieve the flow area, thus bringing about the acceleration of the flow of steam; in the top part, as high as will be dictated by the soil conditions and necessities and by the transport requirements, there is located the cooling cover (9) (in the shape of an inverted boot) which on its outside is furnished with ventilating or heat dissipating fins (10), and on its underside has (separated by v shaped sections) grooves (11) which facilitate the accumulation of steam, thus bringing about water condensation and runoff through thermal shock of the steam on hand in the ceiling; this cover (9) has a slanted position which allows for the drops of already condense water to slide down to a descending pipeline (12); the flow area or diameter of the descending pipeline (12) shows a constant increase which favors the flow of water by reducing frictional losses and increasing the volume of moving water, which in turn will cause a larger flow of rising steam due to the velocity of the fluid current, thus facilitating and accelerating the systems operation.

FIG. 3 finally illustrates a trap (13) comprising a counterweight (14) which only allows for the trap (13) to open until the tower is fully loaded, so as to only cause a flow and thus the real build up of a vacuum to occur when the pipeline is completely full, which will promote the fluidity of the steam; the trap's (13) or cover's counterweight (14) acts in combination with a spring (15) in order to bring about a closure as soon as there is a lack of water flow.

The materials used will of course be selected according to their intended function; the funnel, for instance, will be made of a material or comprise a lining which isolates water, so as not to loose thermal energy because of the temperature prevailing in the water table, and also intended for a longer service life in spite of the effects of corrosion; it is obvious that it must be possible to dismantle the vat in order to allow for it to be replaced when necessary, due to the accumulation of salts or scaling. The tower will be made of thermal materials and painted in dark colors, and of materials which promote the reception of sun rays while reflecting a minimum of heat, in order to preserve the heat necessary for the steam to rise and thus act like a chimney. Also the shape of the various elements may vary; for instance, the tubular pipeline may be cylindrical, square or hexagonal, etc.; the trap may be placed off center, or may have the same configuration as the pipeline; it is also possible to use elements or devices serving the same purpose or even add some which may improve the harnessing of solar energy, e.g. a sun tracking system, etc., all of which has been considered by the inventor.

1. Method for the thermo solar distillation and transportation of water from a water table which comprises the steps of: harnessing solar energy; have it strike on a focal point which comprises a pipe in which circulates a fluid; transport the fluid to a coil submerged in a water table in order to bring about the evaporation of the water, dislodging the resulting higher salt density through the underside outlet of the funnel; induce the rising of the steam through the tower, condense the steam in the top part of the tower and allow the condensed water to fall along a pipeline laid in a descending slope.

2. Method according to claim 1, characterized in that the solar energy is harnessed by means of a photovoltaic cell panel and the fluid is brought about to circulate using a pump driven by the electricity furnished by the cells.

3. Apparatus for the thermo solar distillation and transportation of water from a water table which comprises the functional technical combination of: thermo solar energy collectors of the parabolic channel type which concentrate the thermal energy on a focal point, canals which individually consist of a pipe through which flows an oil which, by means of a pump driven by photovoltaic cells is brought about to circulate through a coil submerged in funnel where it brings about the evaporation of the water and the dislodgement of the remaining water having higher salt density; a tower in which the steam rises to a ceiling plate furnished with cooling fins, on the underside of which the steam condenses and is collected in runoff grooves; a pipeline laid in a descending slope allows the water to descend and be transported by gravity.

4. Apparatus according to claim 3, characterized in that it comprises a tower which expands at regular intervals as it rises, a descending pipeline which expands at regular intervals while going down, and a trap at the lower end which includes a counterweight and spring, which opens and closes depending upon the quantity of water in the pipeline.
